(19) United States
(12) Patent Application Publication
(10) Pub. No.: US 2025/0074200 A1
(43) Pub. Date: Mar. 6, 2025

(54) REGENERATIVE BRAKING CONTROL FOR IMPROVED DRIVABILITY ON ELECTRIFIED PROPULSION SYSTEMS

(71) Applicant: FCA US LLC, Auburn Hills, MI (US)

(72) Inventors: Nursefa Zengin, Bowmanville (CA); Shawali Chaudhury, Bluff Dale, TX (US)

(21) Appl. No.: 18/459,483

(22) Filed: Sep. 1, 2023

(51) Int. Cl. B60L 7/26

(52) U.S. Cl. CPC B60L 7/26; B60L 2240/421; B60L 2240/423

(57) ABSTRACT

A control system for an electrified powertrain of an electrified vehicle includes a controller configured to determine a regenerative torque request and a friction braking torque request to collectively satisfy a braking torque request indicative of a desired braking torque to be applied to a driveline of the electrified vehicle and, when the regenerative torque request is greater than zero, obtain a driveline model configured to model transient dynamics of the driveline including a driveline shaft connected between friction brakes of the electrified vehicle and an electric motor of the electrified powertrain, adjust a motor torque command for the electric motor based on the regenerative torque request, the model, and the speeds and/or positions of the electric motor and the driveline shaft, and control the electric motor based on the motor torque command to perform regenerative braking and thereby improve vehicle regenerative braking performance and/or vehicle drivability.

### FIELD

The present application generally relates to electrified vehicles and, more particularly, to regenerative braking control for improved drivability on electrified propulsion systems.

### BACKGROUND

A powertrain is configured to generate and transfer torque to a driveline of a vehicle for propulsion. Some electrified powertrains include an electric motor configured for regenerative braking that is separated from friction brakes by a shaft. Conventional control systems for such powertrains assume this shaft is stiff for simplicity (i.e., no accounting for driveline dynamics). That is, in reality, this driveline shaft is not entirely stiff and has at least some flexibility. When utilized at low vehicle speeds, regenerative braking via these conventional control systems could result in significant vehicle torque oscillations or “clunk” (noise, vibration, and/or harshness, or “NVH”) that could be noticeable to a driver or passengers of the vehicle. Thus, regenerative braking is typically limited to higher vehicle speeds, which is not optimal for regenerative braking performance (e.g., limited recapture of vehicle kinetic energy). Accordingly, while such conventional electrified powertrain control systems do work for their intended purpose, there exists an opportunity for improvement in the relevant art.

### SUMMARY

According to one example aspect of the invention, a control system for an electrified powertrain of an electrified vehicle is presented. In one exemplary implementation, the control system comprises a set of sensors configured to measure a set of parameters indicative of (i) a braking torque request indicative of a desired braking torque to be applied to a driveline of the electrified vehicle, (ii) at least one of a speed of an electric motor of the electrified powertrain and a position of the electric motor, and (iii) at least one of a speed of a driveline shaft and a position of the driveline shaft, the driveline shaft being connected between friction brakes of the electrified vehicle and the electric motor, and a controller configured to determine a regenerative torque request and a friction braking torque request to collectively satisfy the braking torque request and, when the regenerative torque request is greater than zero, obtain a driveline model configured to model transient dynamics of the driveline including the driveline shaft, adjust a motor torque command for the electric motor based on the regenerative torque request, the model, and the set of parameters, and control the electric motor based on the motor torque command to perform regenerative braking and thereby improve vehicle regenerative braking performance and/or vehicle drivability.

In some implementations, the controller is configured to utilize a linear-quadratic regulator (LQR) with integral action that asymptotically tracks and compensates the regenerative braking torque request. In some implementations, the LQR has a performance index that uses a weighting of a time derivative of electric motor torque and a difference between the regenerative torque request and actual regenerative torque. In some implementations, the controller is configured to extend operation of regenerative braking to lower vehicle speeds to thereby improve the vehicle regenerative braking performance and/or vehicle drivability.

In some implementations, the electric motor is a first electric motor of the electrified powertrain and the electrified powertrain further comprises a second electric motor, an internal combustion engine, and a transmission, wherein the transmission is arranged between the driveline shaft and the first electric motor, and wherein the engine is arranged between the first electric motor and the second electric motor. In some implementations, the model is based on a two inertia-spring-damper system. In some implementations, the model includes (i) a first lumped inertia of the first electric motor, the transmission, and the driveline and (ii) a second lumped inertia of the electrified vehicle and its tires.

In some implementations, the model is defined as follows:

$${\ddot{θ}}_{m} = \frac{1}{{J}_{1}} [ {T}_{m} - {T}_{to} ] , \\ {\ddot{θ}}_{v} = - \frac{1}{{J}_{2}} [ {T}_{v} - {T}_{to} ] , \\ {T}_{to} = c ( {\dot{θ}}_{m} - {\dot{θ}}_{v} ) + k ( {θ}_{m} - {θ}_{v} ) , and \\ {T}_{v} = {T}_{load} + {T}_{fric} ,$$

where J₁ and J₂ are the first and second lumped inertias, respectively, Tₘ is the first electric motor torque, Tₜₒ is transmission output torque, k is a stiffness of the driveline shaft, c is a damping coefficient, T_{load} is road load torque, and T_{fric} is friction braking torque.

According to another example aspect of the invention, a control method for an electrified powertrain of an electrified vehicle is presented. In one exemplary implementation, the control method comprises providing a set of sensors configured to measure a set of parameters indicative of (i) a braking torque request indicative of a desired braking torque to be applied to the driveline, (ii) at least one of a speed of an electric motor of the electrified powertrain and a position of the electric motor, and (iii) at least one of a speed of a driveline shaft and a position of the driveline shaft, the driveline shaft being connected between friction brakes of the electrified vehicle and the electric motor, determining, by a controller, a regenerative torque request and a friction braking torque request to collectively satisfy the braking torque request, and when the regenerative torque request is greater than zero, obtaining, by the controller, a driveline model configured to model transient dynamics of the driveline including the driveline shaft, adjusting, by the controller, a motor torque command for the electric motor based on the regenerative torque request, the model, and the set of parameters, and controlling, by the controller, the electric motor based on the motor torque command to perform regenerative braking and thereby improve vehicle regenerative braking performance and/or vehicle drivability.

In some implementations, the controller is configured to utilize an LQR with integral action that asymptotically tracks and compensates the regenerative braking torque request. In some implementations, the LQR has a performance index that uses a weighting of a time derivative of electric motor torque and a difference between the regenerative torque request and actual regenerative torque. In some implementations, the controller is configured to extend operation of regenerative braking to lower vehicle speeds to thereby improve the vehicle regenerative braking performance and/or vehicle drivability.

In some implementations, the electric motor is a first electric motor of the electrified powertrain and the electrified powertrain further comprises a second electric motor, an internal combustion engine, and a transmission, wherein the transmission is arranged between the driveline shaft and the first electric motor, and wherein the engine is arranged between the first electric motor and the second electric motor. In some implementations, the model is based on a two inertia-spring-damper system. In some implementations, the model includes (i) a first lumped inertia of the first electric motor, the transmission, and the driveline and (ii) a second lumped inertia of the electrified vehicle and its tires.

In some implementations, the model is defined as follows:

$${\ddot{θ}}_{m} = \frac{1}{{J}_{1}} [ {T}_{m} - {T}_{to} ] , \\ {\ddot{θ}}_{v} = - \frac{1}{{J}_{2}} [ {T}_{v} - {T}_{to} ] , \\ {T}_{to} = c ( {\dot{θ}}_{m} - {\dot{θ}}_{v} ) + k ( {θ}_{m} - {θ}_{v} ) , and \\ {T}_{v} = {T}_{load} + {T}_{fric} ,$$

where J₁ and J₂ are the first and second lumped inertias, respectively, Tₘ is the first electric motor torque, Tₜₒ is transmission output torque, k is a stiffness of the driveline shaft, c is a damping coefficient, T_{load} is road load torque, and T_{fric} is friction braking torque.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIGS. 1A-1B are functional block diagrams of an electrified vehicle and an example electrified powertrain and an example control system according to the principles of the present application;

FIGS. 2A-2B are schematic diagrams of an example dynamic driveline model and an example architecture for the control system according to the principles of the present application;

FIGS. 3A-3C are plots of example regenerative braking torque and electric motor torque and associated driveline oscillations according to the principles of the present application; and

FIG. 4 is a flow diagram of an example control method for an electrified powertrain of an electrified vehicle according to the principles of the present application.

### DESCRIPTION

As previously discussed, regenerative braking actuation relies upon proper coordination between mechanical frictions brakes and electric motor torque. In one particular electrified powertrain architecture having two electric motors and an internal combustion engine, the two actuators responsible for delivering the total driver brake torque request are separated by a flexible driveline shaft, which could potentially result in losses due to the unmodelled driveline dynamics, particularly at low vehicle speeds. This limits the use of regenerative braking at low vehicle speeds on electrified vehicle. Existing or conventional control techniques utilize an empirical solution that assumes a stiff (i.e., non-flexible) driveline shaft for simplicity. Due to the unmodelled driveline dynamics, torque oscillations could potentially happen at low speeds. Assuming a stiff driveline shaft could result in incorrect accounting of regenerative braking torque at wheels, ultimately impacting regenerative braking and friction braking coordination. Inaccurate coordination of the two actuators responsible for delivering driver's braking torque request results in poor drivability.

Accordingly, improved control systems and methods for an electrified powertrain of an electrified vehicle are presented herein. More specifically, these control systems and methods do not assume a stiff driveline shaft and instead model the driveline (and, more particularly, this driveline shaft) to account for driveline dynamics, which are a critical component for smooth braking torque delivery, and improper accounting of such dynamics could result in torque oscillation at the vehicle wheels. The current invention relates to the control of regenerative braking for proper coordination between mechanical brakes and electric motor torque during a braking event on any propulsion system where in a motor capable of regenerative braking is separated from friction brakes by a shaft. During a typical regenerative braking event, both regen brakes and friction brakes need to be coordinated correctly in order to deliver smooth drivability.

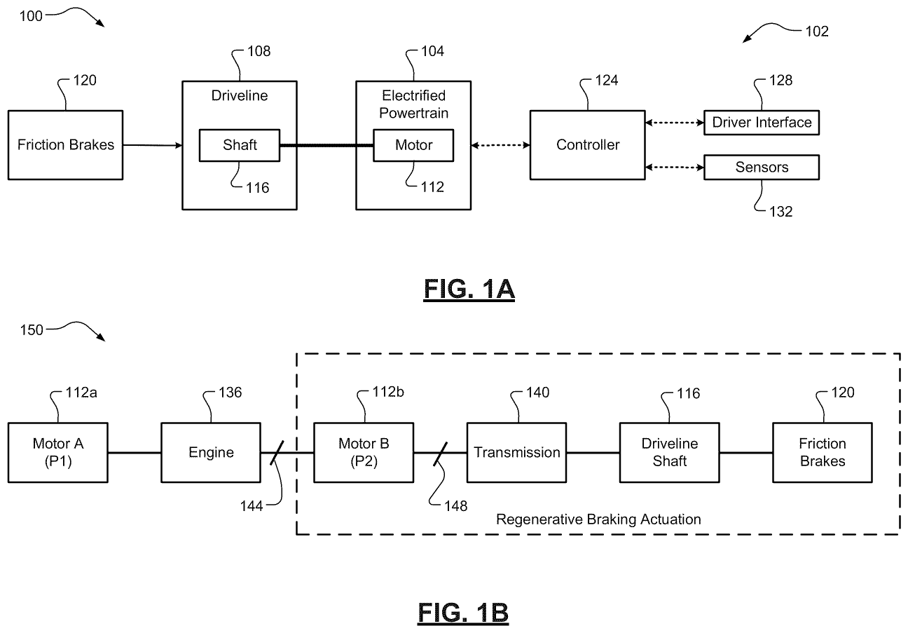

Referring now to FIGS. 1A-1B, functional block diagrams of an electrified vehicle 100 and an example electrified powertrain 104 and an example control system 102, 150 according to the principles of the present application are illustrated. The electrified powertrain 104 is configured to generate and transfer torque to a driveline 108, such as via a transmission 140. The electrified powertrain 104 includes at least one electric motor 112 (e.g., electric motor 112b, or “P2”) and, optionally, a second electric motor (e.g., electric motor 112a, or “P1”) and/or an internal combustion engine 136. A shaft 116 of the driveline 108 (“driveline shaft 116”) is connected between the electric motor 112 or 112b (its output shaft) and friction brakes 120 of the electrified vehicle 100. A controller 124 is configured to control operation of the electrified powertrain 104, including generating and transferring drive torque to the driveline 108 to satisfy a driver torque request (e.g., from a driver interface 128, such as an accelerator pedal) and based on measurements or feedback by a set of one or more sensors 132 (speed/position sensors). Clutches or disconnect devices 144, 148 can selectively open/close to connect the various components, such as to connect the illustrated components for regenerative braking operation. The controller 124 is also configured to perform at least a portion of the techniques of the present application, which will now be described in greater detail.

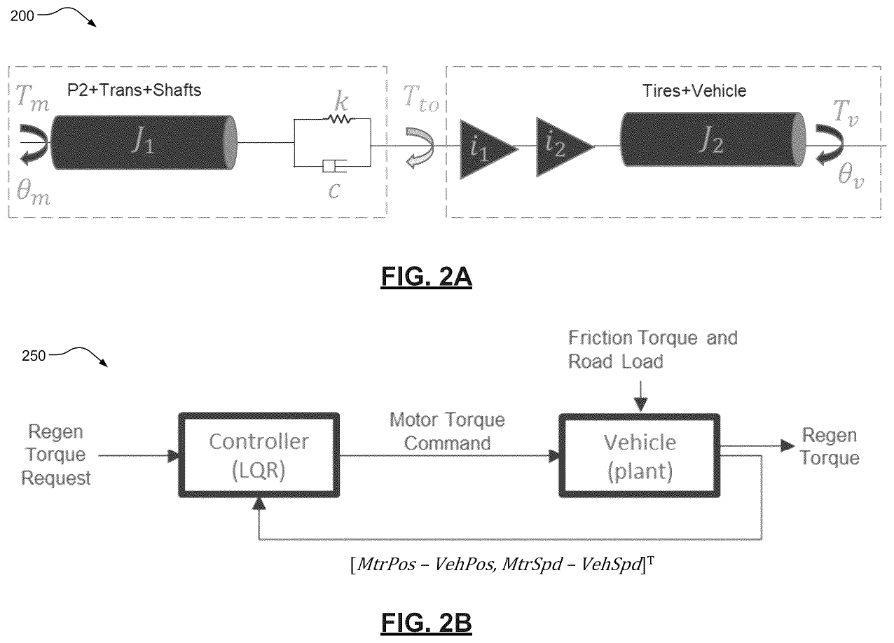

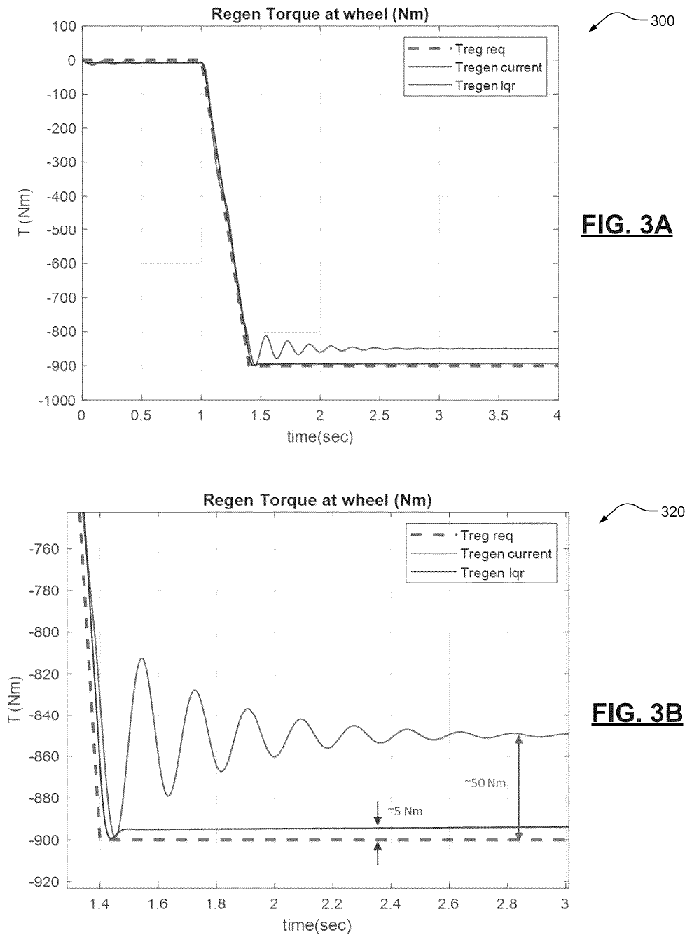

Referring now to FIGS. 2A-2B, schematic diagrams of an example dynamic driveline model 200 and an example architecture 250 for the control system according to the principles of the present application are illustrated. In some implementations, the controller 124, 250 is configured as a linear-quadratic controller (LQR) with integral action, that enables smooth delivery of total braking torque. One primary objective of the present application is to damp driveline torque oscillations while the controller output asymptotically achieves the regenerative torque request at low speeds. While LQR has been utilized before for different vehicle driveline related controls, LQR has not yet been utilized in regenerative braking actuation and, more particularly, for such a particular/unique electrified powertrain configuration as those described herein. The current solution utilizes an optimal LQR controller that has information about driveline dynamics. The LQR with integral action is designed to damp driveline oscillations by compensating the regenerative torque request, which is asymptotically tracked. The controller performance index uses a weighting of the time derivative of the regen torque and the difference between the regen torque demand and the actual regen torque. The LQR controller performance robustness is further improved by introducing integral action on wheel torque to (i) remove torque oscillation, and hence smooth drivability, and (ii) improve driver brake torque request tracking.

While the driveline model is actually quite complex (e.g., due to several parameters characterizing all the driveline dynamics to analyze), a simplified driveline model for a two inertia-spring-damper system has been found to be adequate in representing the driveline dynamics, while also accounting for road load and other driveline losses like transmission and clutch losses. This simplified driveline model represents a full fidelity model proven via virtual analysis. The aim is to be able to model the transient driveline dynamics sufficiently to remove the driveline oscillations with minimal inertias and shaft components. In some implementations, the simplified driveline model is defined as follows:

$${\ddot{θ}}_{m} = \frac{1}{{J}_{1}} [ {T}_{m} - {T}_{to} ] , \\ {\ddot{θ}}_{v} = - \frac{1}{{J}_{2}} [ {T}_{v} - {T}_{to} ] , \\ {T}_{to} = c ( {\dot{θ}}_{m} - {\dot{θ}}_{v} ) + k ( {θ}_{m} - {θ}_{v} ) , and \\ {T}_{v} = {T}_{load} + {T}_{fric} ,$$

where J₁ and J₂ are the first and second lumped inertias, respectively, Tₘ is the electric motor torque, Tₜₒ is transmission output torque, k is a stiffness of the driveline shaft, c is a damping coefficient, T_{load} is road load torque, and T_{fric} is friction braking torque. In some implementations, a discrete state-space model is obtained to be used in controller design where the system states are the differences between motor position and vehicle position, the differences between motor speed and vehicle speed, the system input is electric motor torque, the external input is friction braking torque and road load torque, and the system output is regenerative torque at the vehicle wheels.

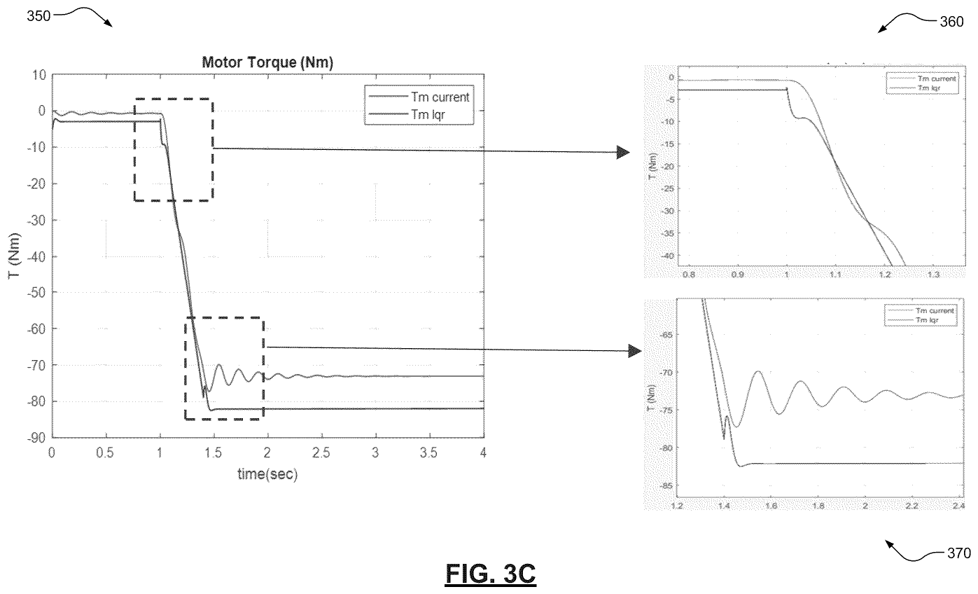

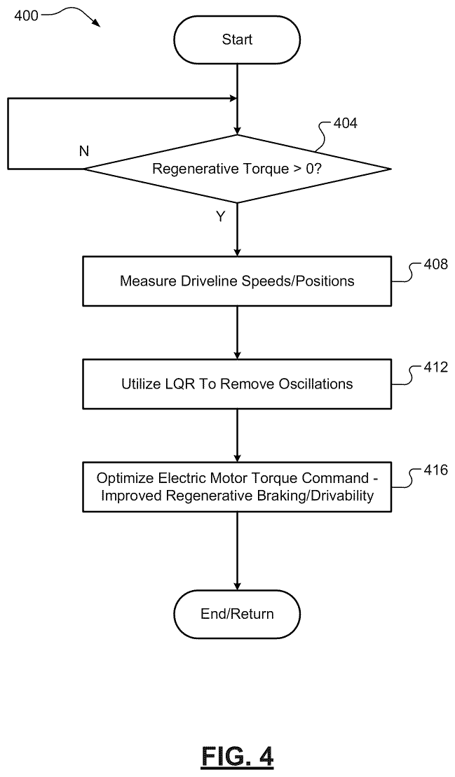

Referring now to FIGS. 3A-3C, plots 300, 320, 350 of example regenerative braking torque and electric motor torque and associated driveline oscillations according to the principles of the present application are illustrated. For example, these example Simulink test results for the implementation of the developed algorithm. As shown, for a 2nd gear Simulink test, desired torque to achieve is determined as ˜900 Newton-meters (Nm). Friction and road load torques are also applied. For the robustness, transmission and clutch losses that were not modeled are considered. Even with these unmodeled dynamics, the controller of the present application performs well and achieves the desired regenerative torque. In addition, compared to the existing/conventional controls, torque oscillations are mostly/acceptably handled.

Referring now to FIG. 4, a flow diagram of an example control method 400 for an electrified powertrain of an electrified vehicle according to the principles of the present application is illustrated. While the method 400 specifically references the electrified vehicle 100 and its components, it will be appreciated that the method 400 could be applicable to any suitable electrified vehicle having an electrified powertrain where a flexible (non-stiff) shaft separates friction brakes and an electric motor associated with regenerative braking. The method 400 begins at 404 where the controller 124 determines whether the regenerative braking torque request is greater than zero. An initial braking torque request could be derived, for example, based on other operating parameter(s) measured or monitored by the sensor(s) 132. For example, the entire braking torque request could be satisfied via friction braking torque (i.e., no regenerative braking desired or acceptable, such as due to a fully-charged battery system). When false, the method 400 ends or returns to 404. When true, the method 400 continues to 408.

At 408, the controller 124 obtains the measured speeds/positions of the various components (the electric motor 112, the driveline shaft 116, the vehicle wheels/tires, etc.). At 412, the controller 124 employs the LQR controller to adjust the electric motor torque command and remove driveline oscillations. At 416, the controller 124 determines and utilizes an optimized torque command for the electric motor 112 to improve vehicle regenerative braking performance and/or vehicle drivability. The method 400 then ends or returns to 404 for one or more additional cycles.

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A control system for an electrified powertrain of an electrified vehicle, the control system comprising:
a set of sensors configured to measure a set of parameters indicative of:
(i) a braking torque request indicative of a desired braking torque to be applied to a driveline of the electrified vehicle,
(ii) at least one of a speed of an electric motor of the electrified powertrain and a position of the electric motor, and
(iii) at least one of a speed of a driveline shaft and a position of the driveline shaft, the driveline shaft being connected between friction brakes of the electrified vehicle and the electric motor; and
a controller configured to:
determine a regenerative torque request and a friction braking torque request to collectively satisfy the braking torque request; and
when the regenerative torque request is greater than zero:
obtain a driveline model configured to model transient dynamics of the driveline including the driveline shaft;
adjust a motor torque command for the electric motor based on the regenerative torque request, the model, and the set of parameters; and
control the electric motor based on the motor torque command to perform regenerative braking and thereby improve vehicle regenerative braking performance and/or vehicle drivability.

2. The control system of claim 1, wherein the controller is configured to utilize a linear-quadratic regulator (LQR) with integral action that asymptotically tracks and compensates the regenerative braking torque request.

3. The control system of claim 2, wherein the LQR has a performance index that uses a weighting of a time derivative of electric motor torque and a difference between the regenerative torque request and actual regenerative torque.

4. The control system of claim 1, wherein the controller is configured to extend operation of regenerative braking to lower vehicle speeds to thereby improve the vehicle regenerative braking performance and/or vehicle drivability.

5. The control system of claim 1, wherein the electric motor is a first electric motor of the electrified powertrain and the electrified powertrain further comprises a second electric motor, an internal combustion engine, and a transmission, wherein the transmission is arranged between the driveline shaft and the first electric motor, and wherein the engine is arranged between the first electric motor and the second electric motor.

6. The control system of claim 5, wherein the model is based on a two inertia-spring-damper system.

7. The control system of claim 6, wherein the model includes (i) a first lumped inertia of the first electric motor, the transmission, and the driveline and (ii) a second lumped inertia of the electrified vehicle and its tires.

8. The control system of claim 7, wherein the model is defined as follows:
$${\ddot{θ}}_{m} = \frac{1}{{J}_{1}} [ {T}_{m} - {T}_{to} ] , \\ {\ddot{θ}}_{v} = - \frac{1}{{J}_{2}} [ {T}_{v} - {T}_{to} ] , \\ {T}_{to} = c ( {\dot{θ}}_{m} - {\dot{θ}}_{v} ) + k ( {θ}_{m} - {θ}_{v} ) , and \\ {T}_{v} = {T}_{load} + {T}_{fric} ,$$
where J₁ and J₂ are the first and second lumped inertias, respectively, Tₘ is the first electric motor torque, Tₜₒ is transmission output torque, k is a stiffness of the driveline shaft, c is a damping coefficient, T_{load} is road load torque, and T_{fric} is friction braking torque.

9. A control method for an electrified powertrain of an electrified vehicle, the control method comprising:
providing a set of sensors configured to measure a set of parameters indicative of:
(i) a braking torque request indicative of a desired braking torque to be applied to the driveline,
(ii) at least one of a speed of an electric motor of the electrified powertrain and a position of the electric motor, and
(iii) at least one of a speed of a driveline shaft and a position of the driveline shaft, the driveline shaft being connected between friction brakes of the electrified vehicle and the electric motor;
determining, by a controller, a regenerative torque request and a friction braking torque request to collectively satisfy the braking torque request; and
when the regenerative torque request is greater than zero:
obtaining, by the controller, a driveline model configured to model transient dynamics of the driveline including the driveline shaft;
adjusting, by the controller, a motor torque command for the electric motor based on the regenerative torque request, the model, and the set of parameters; and
controlling, by the controller, the electric motor based on the motor torque command to perform regenerative braking and thereby improve vehicle regenerative braking performance and/or vehicle drivability.

10. The control method of claim 9, wherein the controller is configured to utilize a linear-quadratic regulator (LQR) with integral action that asymptotically tracks and compensates the regenerative braking torque request.

11. The control method of claim 10, wherein the LQR has a performance index that uses a weighting of a time derivative of electric motor torque and a difference between the regenerative torque request and actual regenerative torque.

12. The control method of claim 9, wherein the controller is configured to extend operation of regenerative braking to lower vehicle speeds to thereby improve the vehicle regenerative braking performance and/or vehicle drivability.

13. The control method of claim 9, wherein the electric motor is a first electric motor of the electrified powertrain and the electrified powertrain further comprises a second electric motor, an internal combustion engine, and a transmission, wherein the transmission is arranged between the driveline shaft and the first electric motor, and wherein the engine is arranged between the first electric motor and the second electric motor.

14. The control method of claim 13, wherein the model is based on a two inertia-spring-damper system.

15. The control method of claim 14, wherein the model includes (i) a first lumped inertia of the first electric motor, the transmission, and the driveline and (ii) a second lumped inertia of the electrified vehicle and its tires.

16. The control method of claim 15, wherein the model is defined as follows:
$${\ddot{θ}}_{m} = \frac{1}{{J}_{1}} [ {T}_{m} - {T}_{to} ] , \\ {\ddot{θ}}_{v} = - \frac{1}{{J}_{2}} [ {T}_{v} - {T}_{to} ] , \\ {T}_{to} = c ( {\dot{θ}}_{m} - {\dot{θ}}_{v} ) + k ( {θ}_{m} - {θ}_{v} ) , and \\ {T}_{v} = {T}_{load} + {T}_{fric} ,$$
where J₁ and J₂ are the first and second lumped inertias, respectively, Tₘ is the first electric motor torque, Tₜₒ is transmission output torque, k is a stiffness of the driveline shaft, c is a damping coefficient, T_{load} is road load torque, and T_{fric} is friction braking torque.
